(19) United States
(12) Patent Application Publication
(10) Pub. No.: US 2019/0206174 A1
(43) Pub. Date: Jul. 4, 2019

(54) AUTOMATED DISPENSING MACHINE WITH IMPROVED SECURITY

(71) Applicant: Idemia Identity & Security USA LLC, Billerica, MA (US)

(72) Inventors: Stephen Miu, Chelmsford, MA (US); Timothy J. Brown, Tampa, FL (US)

(73) Assignee: Idemia Identity & Security USA LLC, Billerica, MA (US)

(21) Appl. No.: 16/229,293

(22) Filed: Dec. 21, 2018

Related U.S. Application Data
(60) Provisional application No. 62/612,043, filed on Dec. 29, 2017.

(51) Int. Cl. G07F 9/02; G06F 21/44; G06F 21/32

(52) U.S. Cl. CPC G07F 9/026; G06F 2221/2149; G06F 21/32; G06F 21/44

(57) ABSTRACT

An automated dispensing machine includes a storage container configured to store a product. An identification sensor of the automated dispensing machine is configured to read, from an identification document of a user, identification data of the user. A biometric sensor is configured to capture, from the user, biometric data of the user. An identity authentication module is coupled to the identification sensor and the biometric sensor. The identity authentication module is configured to obtain information representing whether the identification data matches the biometric data. A product dispenser is coupled to the identity authentication module and the storage container. The product dispenser is configured to dispense, to the user, the product stored in the storage container responsive to the identification data matching the biometric data.

### CROSS-REFERENCE TO RELATED APPLICATIONS

This application claims the right of priority to U.S. Provisional Application No. 62/612,043, filed on Dec. 29, 2017, which is incorporated by reference in its entirety.

### FIELD OF THE INVENTION

This description relates generally to automated dispensing machines and specifically to an automated dispensing machine with improved security.

### BACKGROUND

Vending machines are used to store and dispense goods to customers. However, a bad actor, such as an unauthorized user, can attempt to access a vending machine, especially if the vending machine is in an isolated area. For example, the value of a certain product stored in the vending machine can attract an unauthorized user to access it. This problem can be especially prevalent for goods, such as controlled substances, which are to be dispensed only to authorized users. Security is therefore a challenge, especially for automated vending machines.

### SUMMARY

An automated dispensing machine is disclosed. The automated dispensing machine includes a storage container configured to store a product. An identification sensor is configured to read, from an identification document of a user, identification data of the user. A biometric sensor is configured to capture, from the user, biometric data of the user. An identity authentication module is coupled to the identification sensor and the biometric sensor. The identity authentication module is configured to obtain information representing whether the identification data matches the biometric data. A product dispenser is coupled to the identity authentication module and the storage container. The product dispenser is configured to dispense, to the user, the product stored in the storage container responsive to the identification data matching the biometric data.

In some embodiments, a mobile device is configured to read security data and identification data of a user from an identification document of the user. Information representing whether the security data matches the identification data is obtained. First biometric data of the user is captured. Information representing whether the identification data matches the first biometric data is obtained. Responsive to the identification data matching the first biometric data, information representing that the identification data matches the first biometric data is transmitted to an automated dispensing machine. The automated dispensing machine is communicatively coupled to the mobile device and configured to capture second biometric data of the user. Responsive to the second biometric data matching the first biometric data, a product stored in the automated dispensing machine is dispensed to the user.

These and other aspects, features, and implementations can be expressed as methods, apparatus, systems, components, program products, means or steps for performing a function, and in other ways.

These and other aspects, features, and implementations will become apparent from the following descriptions, including the claims.

### BRIEF DESCRIPTION OF THE DRAWINGS

FIG. 1 shows a block diagram of an environment for an automated dispensing machine, in accordance with one or more embodiments.

FIG. 2 shows a block diagram of an architecture for an automated dispensing machine, in accordance with one or more embodiments.

FIG. 3 illustrates a process for operating an automated dispensing machine, in accordance with one or more embodiments.

### DETAILED DESCRIPTION

An automated dispensing machine is disclosed herein. The automated dispensing machine is equipped with sensors to inspect an identification document. The automated dispensing machine is also equipped with sensors to inspect an authorization document. The automated dispensing machine is also equipped with sensors to collect biometric data from a user. A network communications interface can be included to communicate with state and commercial databases. An identity authentication module is used to make a determination of the validity of a request for a product by the user using the identification document and the authorization document. The automated dispensing machine can further generate an audit log for use in forensic activities investigating unauthorized use of the automated dispensing machine.

In one example, a driver's license or a state ID card is used as the identification document. The automated dispensing machine combines card-scanning and receipt of biometric data to confirm that the identification document is authentic. The biometric data captured is compared to a biometric database or a visual representation on the identification document. Identification data from the identification document can be checked against a system of record, which is controlled by a regulating agency. In some embodiments, an approved quantity of the product, which is to be dispensed for an approved time period, is dispensed to an agent or user. The agent conducts the transaction and registers the sale with the system of record. The approved quantity and time period for the user is registered and an authorization database is updated. In some implementations, the transaction and quantity of the product dispensed is tallied with a revenue collection agency.

The embodiments disclosed herein therefore assist with the regulation and enforcement of medical prescriptions for controlled substances by centralizing the recordkeeping of such transactions and linking the user's identity to a name on the prescription (authorization document). A method to use transactional metadata recordkeeping to assist with tax revenue collection by the regulating agency is also disclosed.

### Environment for an Automated Dispensing Machine

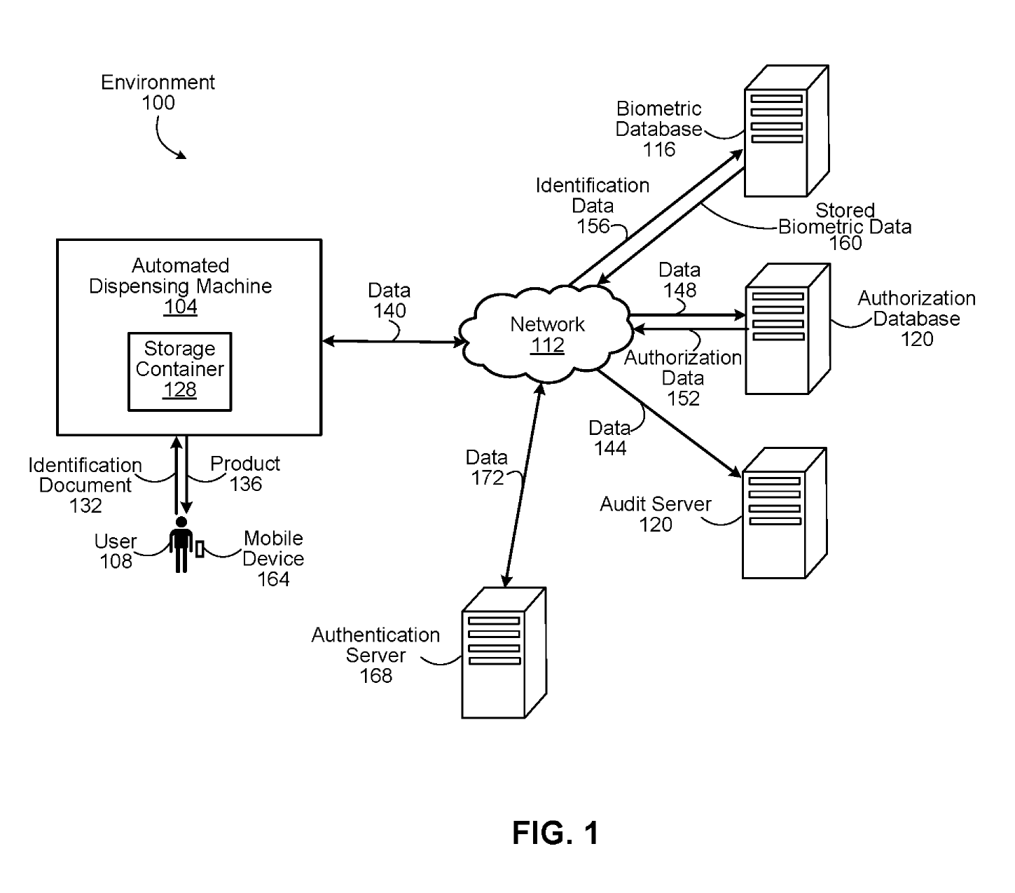

FIG. 1 shows a block diagram of an environment 100 for an automated dispensing machine 104 with improved physical security, in accordance with one or more embodiments. The environment includes the automated dispensing machine 104, a user 108, a mobile device 164, a network 112, an authentication server 168, a biometric database 116, an authorization database 120, and an audit server 120. In other embodiments, the environment 100 includes additional or fewer components than those described herein. Similarly, the functions can be distributed among the components or different entities in a different manner than is described here.

The automated dispensing machine 104 dispenses a product 136 to the user 108. In one example, the product 136 is a controlled substance or a medication, such as medical marijuana, requiring a prescription from a doctor. The supply and dispensing of such a product 136 can be closely monitored by government regulatory and law enforcement agencies. The automated dispensing machine 104 includes a storage container 128 to store the product 136. The storage container 128 can be a secure metal (e.g., steel), carbon fiber, or armored container to prevent an unauthorized user from breaking in and retrieving the product 136 or to prevent an authorized user 108 or agent of the user 108 from acting in an unauthorized manner, e.g., retrieving more of the product 136 than is authorized or reusing a medical prescription to obtain additional product 136 for illegal resale.

In some embodiments, the automated dispensing machine 104 reads identification data of the user 108 from an identification document 132 of the user 108. For example, the identification document 132 can be a driver's license, a medical ID card, or a state ID card. The identification data can be the name of the user 108, age of the user 108, insurance information of the user 108, or a combination thereof. The automated dispensing machine 104 captures biometric data of the user 108. The automated dispensing machine 104 obtains information representing whether the identification data matches the biometric data. Responsive to the identification data matching the biometric data, the automated dispensing machine 104 dispenses the product 136 stored in the storage container 128 to the user 108.

In some embodiments, the mobile device 164 is configured to read security data and the identification data 156 of the user 108 directly from the identification document 132 of the user 108. For example, a camera of the mobile device 164 can scan a driver's license or state ID card of the user 108. The security data can be, but is not limited to, an inlaid profile photograph of the user, a barcode, a QR code, an RFID tag, or a combination thereof. The mobile device 164 is further configured to verify whether the identification document 132 of the user 108 is authentic or valid. The mobile device 164 verifies whether the identification document 132 of the user 108 is authentic by obtaining information representing whether the security data matches the identification data 156. In some embodiments, the mobile device 164 obtains the information representing whether the security data matches the identification data 156 from an authentication module of the mobile device 164 itself. In some embodiments, the mobile device 164 obtains the information representing whether the security data matches the identification data 156 from an authentication server 168 that is connected to the network. For example, the mobile device 164 can obtain the data 172 representing whether the security data matches the identification data 156 from the authentication server 168.

In some embodiments, the mobile device 164 is configured to perform identity verification on the mobile device 164 itself. The mobile device 164 captures biometric data of the user 108. The biometric data can include, but is not limited to, a selfie or photograph of the user 108, a fingerprint of the user 108, a voice sample of the user 108, or a combination thereof. The mobile device 164 is further configured to obtain information representing whether the identification data 156 of the user 108 matches the biometric data. In some embodiments, the mobile device 164 is configured to perform the biometric data matching itself to verify whether the identification document 132 belongs to the user 108. In some embodiments, the mobile device 164 is configured to obtain, from the biometric database 116, stored biometric data 160 corresponding to the identification data 156. The mobile device 164 is further configured to compare the captured biometric data to the stored biometric data 160 corresponding to the identification data 156 to verify whether the identification document 132 belongs to the user 108.

In some embodiments, the mobile device 164 is communicatively coupled to the automated dispensing machine 104 by a method including, but not limited to, Bluetooth, Wi-Fi, Near Field Communication (NFC), the network 112, or a combination thereof. The mobile device 164 is configured to transmit, to the automated dispensing machine 104, information representing that the identification data 156 matches the biometric data. The information representing that the identification data 156 matches the biometric data is transmitted to the automated dispensing machine 104 responsive to the mobile device 164 determining that the identification data 156 matches the biometric data. For example, the information representing that the identification data 156 matches the biometric data can include, but is not limited to, an authentication bit or byte, an ASCII message, a result code, or a combination thereof.

In some embodiments, the mobile device 164 is further configured to retrieve, using an authorization document of the user 108, authorization data 152 corresponding to the product 136 from an authorization database 120. The authorization document references the product 136. For example, the authorization document of the user 108 can be a prescription or a medical release. The authorization data 152 can be a message that the prescription is valid and that the product 136 can indeed be dispensed to the user 108. The mobile device 164 is configured to scan or take a picture of the authorization document and transmit data 148 read from the authorization document to the authorization database 120. Using the authorization data 152 retrieved from the authorization database 120, the mobile device 164 determines whether the authorization data 152 corresponding to the product 136 is valid.

In some embodiments, the automated dispensing machine 104 also captures biometric data of the user 108 once the user 108 initiates a transaction at the automated dispensing machine 104. The capturing of the biometric data by the automated dispensing machine 104 is to verify that the person performing the transaction is indeed the user 108 whose identification document 132 was authenticated earlier. In some embodiments, responsive to the biometric data captured by the automated dispensing machine 104 matching the biometric data captured by the mobile device 164, the product 136 stored in the automated dispensing machine 104 is dispensed to the user 108. In some embodiments, the automated dispensing machine 104 verifies that the biometric data captured by the automated dispensing machine 104 matches the authentication data 156 read from the authentication document 132 of the user 108. Responsive to the biometric data captured by the automated dispensing machine 104 matching the authentication data 156, the product 136 stored in the automated dispensing machine 104 is dispensed to the user 108.

The authentication server 168 is coupled to the network 112 to receive the identification data 156 and biometric data. The authentication server 168 is configured to generate information representing whether the identification data 156 from the identification document 132 matches biometric data captured from the user 108. In some embodiments, the authentication server 168 determines whether the identification data 156 matches the biometric data of the user 108 by retrieving, from the biometric database 116, the stored biometric data 160 corresponding to the identification data 156.

In some embodiments, the authentication server 168 performs a mathematical hash on one or more values appearing in the identification data 156 to reference an anonymous database label on which one or more biometric values are stored. The authentication server 168 can then poll the reference data and validate the identity of the user 108 electronically. In some embodiments, the authentication server 168 compares biometric data to the stored biometric data 160 by analyzing fingerprints of the user 108, for example, by comparing several features of the print pattern. The authentication server 168 can compare patterns, which are aggregate characteristics of ridges, and minutia points, which are unique features found within the patterns. Capture of the biometric data and comparison against the biometric database 116 or a visual representation on the identification document 132 therefore can be used to confirms that the user 108 presenting the authentic card is in fact the user represented by the card.

In some embodiments, the user 108 pre-registers an identity on the mobile device 164 using an electronic token on the mobile device 164. For example, the mobile device 164 captures a driver's license image and a photograph of the user 108, validates the driver's license, and matches the driver's license to the photograph of the user 108. The electronic token can contain one or more validated attributes from the driver's license and the photograph of the user 108. A length of time can then pass before the user 108 performs the transaction on the automated dispensing machine 104. The user 108 approaches the automated dispensing machine 104 and uses the mobile device 164 to interact with the automated dispensing machine 104 using any of NFC technology, Bluetooth technology, or by scanning a QR code. The automated dispensing machine 104 transmits a request to obtain the validated attributes of the user 108 from the electronic token. The mobile device 164 releases the validated attributes of the user 104 to the automated dispensing machine 104. The automated dispensing machine 104 dispenses the product 136.

The user 108 is a human user, e.g., a patient who has been prescribed the product 136. In some embodiments, the user 108 is an agent of a patient, e.g., a friend, a representative, a guardian, etc.

The network 112 can include networking resources (for example, networking equipment, nodes, routers, switches, and networking cables) that interconnect the automated dispensing machine 104 to the biometric database 116, an authorization database 120, and an audit server 120 and help facilitate the automated dispensing machine 104's access to data storage and cloud computing services. The automated dispensing machine 104 transmits data 140 (e.g., identification data 156 of the user 108 or biometric data of the user 108) to the network 112. The automated dispensing machine 104 receives authorization data 152 of the product 136 from an authorization database 120 via the network 112. In an embodiment, the network 112 represents any combination of one or more local networks, wide area networks, or internetworks coupled using wired or wireless links deployed using terrestrial or satellite connections. Data exchanged over the network 112, is transferred using any number of network layer protocols, such as Internet Protocol (IP), Multiprotocol Label Switching (MPLS), Asynchronous Transfer Mode (ATM), Frame Relay, etc. Furthermore, in embodiments where the network 112 represents a combination of multiple sub-networks, different network layer protocols are used at each of the underlying sub-networks. In some embodiments, the network 112 represents one or more interconnected internetworks, such as the public Internet or a secure channel (e.g., a VPN) from the automated dispensing machine 104 to government regulatory servers.

The biometric database 116 stores biometric data of authorized users of the automated dispensing machine 104 or the network 112. The stored biometric data 160 within the biometric database 116 is used to validate the identity of the user 108, validate the identification document 132, secure the dispensing transaction, or a combination thereof. For example, the automated dispensing machine 104 obtains information representing whether the identification data 156 matches the biometric data of the user 108 by retrieving, from the biometric database 116, stored biometric data 160 corresponding to the identification data 156. The stored biometric data 160 can include but is not limited to fingerprints of the user 108, an iris scan, a retina scan, a voice recognition sample, or a combination thereof. The automated dispensing machine 104 compares biometric data of the user 108 captured by a biometric sensor of the automated dispensing machine 104 to the stored biometric data 160 corresponding to the identification data 156. In some embodiments, the biometric data 160 is stored directly on the automated dispensing machine 104.

The authorization database 120 stores information about authorization documents, e.g., medical prescriptions, whether a prescription has been refilled and the number of times it has been refilled, etc. The automated dispensing machine 104 can scan an authorization document presented by the user 108, transmit data 148 read from the authorization document, and retrieve authorization data 152 from the authorization database 120 corresponding to the read data 148. In some embodiments, the authorization data 152 is stored directly on the automated dispensing machine 104.

The audit server 120 stores the identification data 156 of the user 108, the biometric data of the user 108, or the authorization data 152 of the product 136 after a transaction has completed. The automated dispensing machine 104 transmits data 144 (e.g., identification data 156 of the user 108, biometric data of the user 108, authorization data 152 of the product 136 retrieved from an authorization database 120) to the audit server 120 for storage. The storage of the data 144 maintains a record of successful transactions as well as transactions by unauthorized users or unauthorized activity by authorized users for future use by government regulatory agencies and law enforcement.

Among other benefits and advantages of the embodiments disclosed herein, the automated dispensing machine with improved physical security deters illicit activity by authorized agents (e.g., a pharmaceutical technician or pharmacist) acting improperly. For example, the automated dispensing machine can be installed in an environment alongside authorized agents to ensure technological compliance by the authorized agents. The constituent components of the automated dispensing machine are configured to work with one another to dispense controlled substances in a manner designed to deter illicit use and comply with applicable regulations.

In embodiments in which document authentication and identity verification is performed on a mobile device itself, the automated dispensing machine is cheaper to manufacture and cheaper to operate. Older automated dispensing machines can be cost-effectively retrofitted with the newer technology. Therefore, the methods by which identity is verified can be upgraded or expanded with minimal impact to the installed base of existing vending machines. The approach of performing identity verification on the mobile device can be expanded to additional retail solutions such as point-of-sale (POS) technologies used in self-service checkouts at grocery locations. In some embodiments, the identity verification and authentication techniques disclosed herein can be used to design automated dispensing machines to dispense alcohol at stadiums or other venues only to users who are above a certain age.

The automated dispensing machine reduces the impact of a compromised database that an unauthorized electronic eavesdropper (e.g., a hacker) can use to manufacture counterfeit products using serial numbers from the database. The disclosed embodiments control the user's access to medication and prevent problems arising from paper prescriptions photocopied by a user and then brought to an agent or dispensary. Moreover, possible drug abuse by the user and making the user a target of a street crime is prevented. If a user attempts to conduct another transaction within an approved time period, exceeds an approved quantity, or loses control of a prescription (such that an unauthorized user tries to claim the prescription), the automated dispensing machine registers an exception and stops the attempted transaction.

### Architecture for an Automated Dispensing Machine

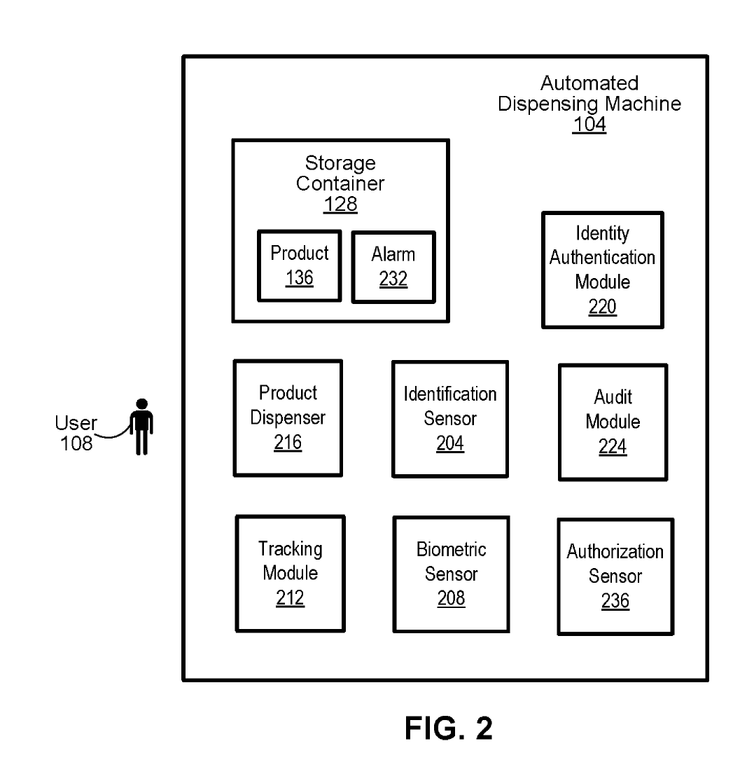

FIG. 2 shows a block diagram of an architecture of an automated dispensing machine 104 with improved physical security, in accordance with one or more embodiments. The automated dispensing machine 104 includes the storage container 128, an identification sensor 204, a biometric sensor 208, an identity authentication module 220, a product dispenser 216, a tracking module 212, an audit module 224, and an authorization sensor 236. In other embodiments, the architecture of the automated dispensing machine 104 includes additional or fewer components than those described herein. Similarly, the functions can be distributed among the components or different entities in a different manner than is described here.

The storage container 128 stores the product 136. The storage container 128 includes an alarm 232. In other embodiments, the storage container 128 includes additional or fewer components than those described herein. Similarly, the functions can be distributed among the components or different entities in a different manner than is described here. The improved physical security of the storage container 128 allows the automated dispensing machine 104 to be used to distribute controlled substances in ways that comply with applicable state and federal laws. In some embodiments, the storage container 128 includes an armored steel container that prevents unauthorized users from penetrating a storage boundary and steal the stored product 136. In some embodiments, the storage container 128 includes a replenishment portal through which authorized personnel can restock the storage container 128.

The alarm 232 detects movement, vibrations, or penetration of the storage container 128. When activated, the alarm 232 is configured to emit an audible warning sound, transmit a signal to a government regulatory agency or law enforcement that an unauthorized user is trying to break in to the storage container 128, or both. The alarm 232 can include, but is not limited to, a pressure sensor to detect pressure or breaking, a temperature sensor to detect heat or a cutting flame applied to the storage container 128, an accelerometer or motion sensor to detect movement or vibrations, or a combinational thereof.

The identification sensor 204 receives an identification document 132 from the user 108. The identification sensor 204 scans or reads the identification document 132 to detect whether the identification document 132 is genuine and indeed belongs to the user 108. The identification sensor 204 can read identification data 156 (e.g., name, age, address, membership status in an insurance plan, or a combination thereof) from the identification document 132.

In some embodiments, the identification sensor 204 includes a barcode reader or an RFID reader. The identification sensor 204 can be an electronic device configured to read and output printed barcodes. The identification sensor 204 can include a light source, a lens and a light sensor translating optical impulses into the identification data 156. The identification sensor 204 can include an RFID reader to gather information from an RFID tag on the identification document 132 and use radio waves to transfer the identification data 156 from the RFID tag to the identity authentication module 220.

In some embodiments, the identification sensor 204 is configured to read the identification data 156 by scanning a barcode, a QR code, or an RFID tag from the identification document 132. The barcode on the identification document 132 is a linear or one-dimensional barcode that uses a series of variable-width lines and spaces to encode the identification data 156 describing the user 108. The barcode can include a few dozen characters. The QR code is a two-dimensional barcode that uses patterns of squares, hexagons, dots, and other shapes to encode the identification data 156. In embodiments, the QR code can also contain an image, a website address, voice, and other types of binary data describing the user 108, such that the automated dispensing machine 104 can make use of the information whether it is connected to a database or not. In other embodiments, the identification document 132 contains a Data Matrix code or PDF417 code that is read by the identification sensor 204 to retrieve the identification data 156.

In some embodiments, the identification sensor 204 is configured to read the identification data 156 by performing optical character recognition on text in the identification document 132 or a scan of an image of a face on the identification document 132. For example, the text in the identification document 132 can be a name, address, status of a patient, etc. The scan of the image of the face can be compared to a real-time image of the face of the user 108 taken by a camera on the biometric sensor 208 or the automated dispensing machine 104.

The biometric sensor 208 receives biometric data from the user 108. The biometric sensor can be a camera, a retina scanner, an iris scanner, a fingerprint reader, a microphone and transducer for voice decoding and recognition, or a combination thereof. The camera can integrate machine vision and can be a CMOS camera or CCD camera for biometric applications that require high quality imagery for identification and verification of the user 108. The retina scanner scans for unique patterns on the retina blood vessels of the user 108. The iris scanner performs automated biometric identification using mathematical pattern-recognition techniques on video images of one or both of the irises of the eyes of the user 108, whose complex patterns are unique, stable, and can be seen from some distance.

The fingerprint reader can be a solid-state fingerprint reader or an optical fingerprint reader. In some embodiments, the biometric sensor 208 captures a fingerprint of the user 108 rolling or touching a finger onto a sensing area. The biometric sensor 208 can alternatively be a non-contact or touchless 3D fingerprint scanner that uses a digital approach to the analog process of pressing or rolling the finger of the user 108. By modelling the distance between neighboring points, the fingerprint can be imaged at a resolution high enough to record all the necessary detail. The microphone and transducer can be part of a speaker recognition system that identifies the user 108 from characteristics of the voice of the user 108. The biometric data can be a fingerprint of the user 108, a voice sample, a retina scan, an iris scan, or a combination thereof.

The identity authentication module 220 is coupled to the identification sensor 204 and the biometric sensor 208 to receive the identification data 156 and the biometric data. The identity authentication module 220 can be implemented in hardware or software. For example, the identity authentication module 220 can be implemented as hardware circuitry or software code that is incorporated into a computing system such as a server system (e.g., a cloud-based server system), a desktop or laptop computer, or a mobile device (e.g., a tablet computer or smartphone). The identity authentication module 220 is configured to obtain information representing whether the identification data 156 from the identification document 132 matches the biometric data.

In some embodiments, the identity authentication module 220 or another module of the automated dispensing machine 104 determines whether the biometric data obtained from the user 108 using the biometric sensor 208 matches the stored biometric data 160 retrieved from the biometric database 116 using the identification data 156. In some embodiments, an authentication system external to the automated dispensing machine 104, for example the authentication server 168 of FIG. 1, determines whether the biometric data obtained from the user 108 using the biometric sensor 208 matches the stored biometric data 160 retrieved from the biometric database 116 using the identification data 156. The identity authentication module 220 obtains information representing whether the identification data 156 from the identification document 132 matches the biometric data. In some embodiments, the identity authentication module 220 determines whether the identification data 156 matches the biometric data of the user 108 by retrieving, from the biometric database 116, stored biometric data 160 corresponding to the identification data 156. The identity authentication module 220 transmits the identification data 156 to the biometric database 116 to perform a lookup.

In some embodiments, the identity authentication module 220 performs a mathematical hash on one or more values appearing in the identification data 156 to reference an anonymous database label on which one or more biometric values are stored. The identity authentication module 220 can then poll the reference data and validate the identity of the user 108 electronically. Using a driver's license or state ID card as the identification document 132, the automated dispensing machine 104 combines card-scanning and capture of biometric data to confirm the identification document 132 is authentic. Capture of the biometric data and comparison against the biometric database 116 or a visual representation on the identification document 132 therefore can be used to confirms that the user 108 presenting the authentic card is in fact the user represented by the card.

The identity authentication module 220 compares the biometric data captured by the biometric sensor 208 to the stored biometric data 160 corresponding to the identification data 156. For example, the identity authentication module 220 can analyze the fingerprints of the user 108 by comparing several features of the print pattern. The identity authentication module 220 can compare patterns, which are aggregate characteristics of ridges, and minutia points, which are unique features found within the patterns. In another embodiment, the identity authentication module 220 uses video camera technology with near infrared illumination of the biometric sensor 208 to acquire images of the iris of the user 108. Digital templates encoded from these patterns by mathematical and statistical algorithms allow the identity authentication module 220 to identify the user 108.

In some embodiments, the identity authentication module 220 requires network connectivity to make dispensation decisions. A regulatory authority that mandates real-time visibility into transactions involving controlled substances can impose such a requirement. Alternatively, the identity authentication module 220 can operate in an autonomous manner or with limited autonomy such that the automated dispensing machine 104 makes dispensation decisions once sufficient information is available. That is, if the identity authentication module 220 determines that the identification document 132 is valid and the stored biometric data 160 made available from the identification document 132 matches the live biometric data, then the automated dispensing machine 104 machine can fill a prescription identified as valid. In this manner, the automated dispensing machine 104 ensures a means to link individual patient claimed identity to a name on the prescription.

The product dispenser 216 dispenses or ejects the product 136 to the user 108. The product dispenser 216 is coupled to the identity authentication module 220 to receive a signal from the identity authentication module 220 that the user 108 is authorized and that the product 136 should be dispensed. The product dispenser 216 is coupled to the storage container 128 to receive the product 136. The product dispenser 216 is configured to dispense, to the user 108, the product 136 stored in the storage container 128 responsive to the identification data 156 matching the biometric data of the user 108. Upon a valid and authorized request for specified inventory from the user 108, an ejection system of the product dispenser 216 can meter and dispense the inventory as warranted.

In some embodiments, the product dispenser 216 releases the product 136 so that the product 136 falls into an open compartment at the bottom of the automated dispensing machine 104 or into a cup that is either released first by the automated dispensing machine 104 or placed by the customer. In some embodiments, the product dispenser 216 unlocks a door or drawer on the automated dispensing machine 104. In other embodiments, the product dispenser 216 uses a metal coil which when ordered by the identity authentication module 220 rotates to release the product 136.

The tracking module 212 monitors a batch number, serial number, or item number of the product 136 dispensed to the user 108. The tracking module 212 can be implemented in hardware or software. For example, the tracking module 212 can be implemented as hardware circuitry or software code that is incorporated into a computing system such as a server system (e.g., a cloud-based server system), a desktop or laptop computer, or a mobile device (e.g., a tablet computer or smartphone). A record is therefore maintained of the date and time a product 136 was dispensed and the number of the product, such that the product 136 can be tracked. The tracking module 212 is coupled to the product dispenser 216 to track the product 136. In some embodiments, the tracking module 212 is configured to read, from the product 136 dispensed by the product dispenser 216, a serial number of the product 136. The serial number can be transmitted to the identity authentication module 220 or the audit server 120 for storage and use by a government regulatory agency or law enforcement. In another embodiment, the tracking module 212 is configured to write, on the product 136 dispensed by the product dispenser 216, a serial number of the product 136. This feature enables the tracking module to date and time stamp each product 136 dispensed and keep a record of the dispensing. The name or identification details of the user 108 (e.g., address, name of doctor, prescription number, number of refills) can also be written by the tracking module 212.

In some embodiments, the tracking module 212 performs serial number management to track which product has been dispensed to which user. A serial number can be written into packaging (or the underlying compound itself) by the tracking module 212. As law enforcement or other investigators later recover improperly distributed products, the serial number can be assigned to the audit server 120 that tracks which users have received which products. In some embodiments, the tracking module 212 prints on the packaging (or product 136 itself) as the product 136 is being dispensed to the user 108. This limits the impact of compromised databases where an unauthorized electronic eavesdropper (e.g., a hacker) can attempt to manufacture counterfeit products using the valid serial numbers. The printing can include nontoxic, ingestible inks written on capsules of medicine, laser etching onto a polymer wrapper or packaging, or ink printing on the packaging.

The audit module 224 is coupled to the identity authentication module 220 to receive data 144 from the identity authentication module 220. The audit module 224 can be implemented in hardware or software. For example, the audit module 224 can be implemented as hardware circuitry or software code that is incorporated into a computing system such as a server system (e.g., a cloud-based server system), a desktop or laptop computer, or a mobile device (e.g., a tablet computer or smartphone). The data 144 can include, but is not limited to, a record of the user 108, the biometric data captured by the biometric sensor 208 from the user 108, the date and time of dispensing of the product 136, the name of the product 136 dispensed, identification data 156 of the user 108, or a combination thereof. This information is stored on the audit server 120. The audit module 224 transmits the data 144 to the audit server 120 for storage and later retrieval by a regulatory agency, law enforcement, or authorized medical professionals. In some embodiments, the audit module 224 generates an audit log for use in forensic activities investigating unauthorized use.

In some embodiments, the audit module 224 facilitates later inspection and investigation into suspect activities. The audit module 224 can include indicia of the nature of the identification document 132 inspected (e.g., a picture of a state driver's license or an indication of the checks or cross-checks performed). The audit module 224 can include a timestamped indication of the prescribing and insurance information that was referenced as well as the biometric data captured for the user 108. A likeness snapshot can be performed such that an actual likeness of the user 108 is captured. For example, if the user is challenged to perform a likeness check (e.g., move face to the left), a likeness audit can be generated by capturing facial metrics across the user's facial rotation. Such metrics and indicia may themselves not reveal any personally identifiable information while also capturing reproducible results such that authenticity can later be determined. In this manner the automated dispensing machine 104 creates a means by which to centralize the recordkeeping of such transactions and accelerates the transactional metadata recordkeeping to assist with tax revenue collection by the regulating agency.

The authorization sensor 236 is configured to retrieve, using an authorization document of the user 108, authorization data 152 corresponding to the product 136 from an authorization database 120. The authorization document (e.g., a prescription, a medical release form, a treatment plan, or a combination thereof) references the product 136 and the user 108. For example, the authorization document can be a prescription or a medical release form that contains the name of the user 108 and the name of the product 136, which is a controlled substance or a drug. The function of the authorization sensor 236 is to read or scan the authorization document to determine whether it is genuine. The authorization sensor 236 uses the authorization data 152 to determine whether the prescription can be filled at the current time, whether the prescription has recently been filled, or whether the prescription is expired. Based on the status of the prescription, the authorization sensor 236 can transmit a signal to a doctor of the user 108 to obtain a refill.

In some embodiments, the identity authentication module 220 is further configured to determine whether the authorization data 152 corresponding to the product 136 is valid. The identity authentication module 220 determines, using the authorization data 152, whether the prescription is proper and whether to dispense the product 136. For example, if the identity authentication module 220 determines that the prescription has already been filled, the identity authentication module 220 will transmit a signal to the product dispenser 216 to stop. The product dispenser 216 is further configured to dispense, to the user 108, the product 136 stored in the storage container 128 responsive to the authorization data 152 being valid.

In some embodiments, the authorization sensor 236 inspects a prescription and references authorizing information associated with the prescription. For example, a paper prescription can include a bar code or other machine-readable information that contains a link tied to an online resource (e.g., authorization database 120) that indicates that a particular identity (or anonymized label) is authorized one or more controlled substances. The online resource (e.g., a health care provider or insurance database) can also reveal whether a prescription has been filled or refilled or whether the desired action represents an illicit attempt to commit fraud.

### Process for Operating an Automated Dispensing Machine

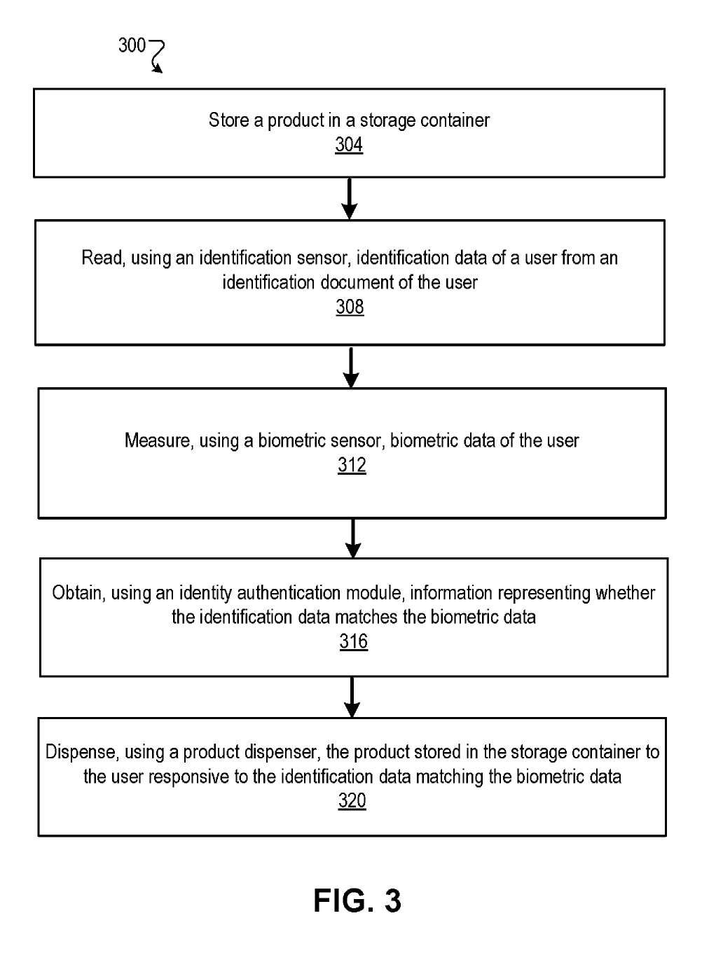

FIG. 3 illustrates a process 300 for operating an automated dispensing machine with improved physical security, in accordance with one or more embodiments. In some embodiments, the process of FIG. 300 is performed by the identity authentication module 220. Other entities, for example, one or more components of the automated dispensing machine 104 perform some or all of the steps of the process 300 in other embodiments. Likewise, embodiments can include different or additional steps, or perform the steps in different orders.

The automated dispensing machine 104 stores 304 a product 136 in a storage container 128. The storage container 128 can be a secure metal (e.g., steel), carbon fiber, or armored container to prevent an unauthorized user from breaking in and retrieving the product 136 or to prevent an authorized user 108 or agent of the user 108 from acting in an unauthorized manner, e.g., retrieving more of the product 136 than is authorized or reusing a medical prescription to obtain additional product 136 for illegal resale.

The automated dispensing machine 104 reads 308, using an identification sensor 204, identification data 156 of a user 108 from an identification document 132 of the user 108. The identification document 132 references the product 136. In some embodiments, the identification sensor 204 includes a bar code reader or an RFID reader. The identification sensor 204 can therefore be an electronic device that can read and output printed barcodes. The identification sensor 204 can include a light source, a lens and a light sensor translating optical impulses into the identification data 156. The identification sensor 204 can include an RFID reader to gather information from an RFID tag on the identification document 132 and use radio waves to transfer the identification data 156 from the RFID tag to the identity authentication module 220.

The automated dispensing machine 104 captures 312, using a biometric sensor 208, biometric data of the user 108. The biometric sensor can be a camera, a retina scanner, an iris scanner, a fingerprint reader, a microphone and transducer for voice decoding and recognition, or a combination thereof. The camera can integrate machine vision and can be a CMOS camera or CCD camera for biometric applications that require high quality imagery for identification and verification of the user 108. The retina scanner scans for unique patterns on the retina blood vessels of the user 108. The iris scanner performs automated biometric identification using mathematical pattern-recognition techniques on video images of one or both of the irises of the eyes of the user 108, whose complex patterns are unique, stable, and can be seen from some distance.

The automated dispensing machine 104 obtains 316, using an identity authentication module 220, information representing whether the identification data 156 matches the biometric data. In some embodiments, the identity authentication module 220 performs a mathematical hash on one or more values appearing in the identification data 156 to reference an anonymous database label on which one or more biometric values are stored. The identity authentication module 220 can then poll the reference data and validate the identity of the user 108 electronically.

The automated dispensing machine 104 dispenses 320, using a product dispenser 216, the product 136 stored in the storage container 128 to the user 108 responsive to the identification data 156 matching the biometric data. In some embodiments, the product dispenser 216 releases the product 136 so that the product 136 falls into an open compartment at the bottom of the automated dispensing machine 104 or into a cup that can be either released first by the automated dispensing machine 104 or placed by the customer.

In some embodiments, the automated dispensing machine 104 is configured to work with an authorized agent on the premises. For example, the user 108 can be challenged to present a paper prescription. As the paper prescription is then handed over from the patient to the agent, the agent can authenticate themselves to the automated dispensing machine 104 in association with the proposed transaction of the user 108. Agent biometric data can be presented to demonstrate the presence of a neutral third party in a manner designed to deter compromise of the automated dispensing machine 104 by fraudulent actors with unrestricted access to the automated dispensing machine 104. For example, a paper prescription can be photocopied by a patient and then brought to a different agent or dispensary, where the same prescription can be transacted again, leading to possible drug abuse or making the patient a target of street crime. By referencing online resources (e.g., biometric database 116, an authorization database 120, and an audit server 120), repeat transactions can be avoided.

Audit information from the audit server 120 can be shared with a state regulatory authority in a de-identified manner such that investigators can identify behavior patterns without compromising personally identifiable information. For example, metadata with anonymized labels can be reported to a state regulatory authority for comparison against other metadata received from other automated dispensing machines. The identification data 156 can be checked against a system of record (SOR), which is controlled by the regulating agency. The approved quantity of medication (and time period) which is to be dispensed is then shared with the agent. The agent conduct the transaction, and then registers the sale with the SOR. The quantity and time for the patient is registered, and the database is updated. The transaction and quantity are then tallied with the revenue collection agency. If the patient attempts to conduct another transaction within the same time period, or exceed the quantity allowed, or loses control of the prescription such that a different individual tries to claim the prescription, the system will register an exception and stop the attempted transaction. In this manner, the automated dispensing machine 104 assists the regulation and enforcement of medical prescriptions for controlled substances

In some embodiments, the product 136 dispensed is not limited to controlled substances. For example, the embodiments disclosed herein can be applied to an automated dispensing machine 104 that dispenses age-controlled materials, such as alcohol and tobacco. When a user 108 wants to obtain age-controlled products, she approaches the automated dispensing machine 104 and pays for the product 136. The automated dispensing machine 104 recognizes that the user 108 is asking for age-controlled products, and prompts the user 108 to scan or insert her identification document 132. The automated dispensing machine 104 can scan the identification document 132 using multi-spectrum light analysis. The automated dispensing machine 104 can request the user 108 to stand in front of a camera (e.g., biometric sensor 208) to capture a portrait image. The automated dispensing machine 104 captures the appropriate images of the identification document 132 (e.g., front and back of a driver's license) and the customer portrait and sends the images to a document authentication system, for example the authentication server 168, for authentication. The document authentication system performs an identity verification as well as a one-to-one face match against the image of the face on the identification document 132. As part of the identity verification proving that the identification document 132 is authentic, the document authentication system can use OCR or other means to identify that user 108 is above the required age threshold. Finally, the document authentication system can perform additional lookups against state related datasets to check for appropriate registration.

Various implementations of devices, systems, and techniques described herein can be realized in digital electronic modulery, integrated modulery, specially designed ASICs (application specific integrated modules), computer hardware, firmware, software, or combinations thereof. These various implementations can include implementation in one or more computer programs that are executable or interpretable on a programmable system including at least one programmable processor, which can be special or general purpose, coupled to receive data and instructions from, and to transmit data and instructions to, a storage system, at least one input device, and at least one output device.

Implementations can involve computer programs (also known as programs, software, software applications or code) include machine instructions for a programmable processor, and can be implemented in a high-level procedural or object-oriented programming language, or in assembly or machine language. As used herein, the terms “machine-readable medium” “computer-readable medium” refers to any computer program product, apparatus or device (e.g., magnetic discs, optical disks, memory, Programmable Logic Devices (PLDs)) used to provide machine instructions or data to a programmable processor, including a machine-readable medium that receives machine instructions as a machine-readable signal. The term “machine-readable signal” refers to any signal used to provide machine instructions or data to a programmable processor.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The elements of a computer can include a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated modules).

To provide for interaction with a user, the systems and techniques described here can be implemented on a computer having a display device (e.g., a CRT (cathode ray tube), LCD (liquid crystal display) monitor, LED (light-emitting diode) or OLED (organic light-emitting diode) monitors) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications can be made without departing from the spirit and scope of the invention. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims. Although many of the operations have been described using a physical identification document, the operations also can be performed using an electronic identification document (or driver's license). For example, a wireless phone can include a trusted application with a driver's license. The prescription also can be stored electronically on a wireless device.

What is claimed is:

1. An automated dispensing machine comprising:
a storage container configured to store a product;
an identification sensor configured to read, from an identification document of a user, identification data of the user;
a biometric sensor configured to capture, from the user, biometric data of the user;
an identity authentication module coupled to the identification sensor and the biometric sensor, the identity authentication module configured to obtain information representing whether the identification data matches the biometric data; and
a product dispenser coupled to the identity authentication module and the storage container, the product dispenser configured to dispense, to the user, the product stored in the storage container responsive to the identification data matching the biometric data.

2. The automated dispensing machine of claim 1, wherein the storage container comprises an armored container configured to prevent an unauthorized user from accessing the product.

3. The automated dispensing machine of claim 1, wherein the storage container comprises an alarm configured to detect at least one of movement, vibrations, or penetration of the storage container.

4. The automated dispensing machine of claim 1, further comprising a tracking module coupled to the product dispenser and configured to read, from the product dispensed by the product dispenser, a serial number of the product.

5. The automated dispensing machine of claim 1, further comprising a tracking module coupled to the product dispenser and configured to write, on the product dispensed by the product dispenser, a serial number of the product.

6. The automated dispensing machine of claim 1, wherein the identification sensor comprises a bar code reader or an RFID reader, the identification sensor configured to read the identification data by performing steps to scan at least one of a bar code, a QR code, or an RFID tag from the identification document.

7. The automated dispensing machine of claim 1, wherein the identification sensor is configured to read the identification data by performing at least one of:
optical character recognition on text in the identification document; or
a scan of an image of a face on the identification document.

8. The automated dispensing machine of claim 1, wherein the identity authentication module is configured to obtain the information representing whether the identification data matches the biometric data by performing steps to:
retrieve, from a biometric database, stored biometric data corresponding to the identification data; and
compare the biometric data captured by the biometric sensor to the stored biometric data corresponding to the identification data.

9. The automated dispensing machine of claim 1, further comprising an authorization sensor configured to retrieve, using an authorization document of the user, authorization data corresponding to the product from an authorization database, wherein the authorization document references the product.

10. The automated dispensing machine of claim 9, wherein the identity authentication module is further configured to determine whether the authorization data corresponding to the product is valid, and wherein the product dispenser is further configured to dispense, to the user, the product stored in the storage container responsive to the authorization data being valid.

11. The automated dispensing machine of claim 1, wherein the biometric sensor comprises at least one of a camera, a fingerprint reader, a retina scanner, or a microphone.

12. The automated dispensing machine of claim 1, further comprising an audit module coupled to the identity authentication module and configured to store at least one of:
the identification data of the user;
the biometric data of the user; or
authorization data of the product retrieved, using an authorization document of the user, from an authorization database.

13. A method comprising:
storing a product in a storage container;
reading, using an identification sensor, identification data of a user from an identification document of the user, wherein the identification document references the product;
capturing, using a biometric sensor, biometric data of the user;
obtaining, using an identity authentication module, information representing whether the identification data matches the biometric data; and
dispensing, using a product dispenser, the product stored in the storage container to the user responsive to the identification data matching the biometric data.

14. The method of claim 13, wherein the reading of the identification data of the user from the identification document of the user comprises at least one of:
scanning a bar code, a QR code, or an RFID tag from the identification document;
performing optical character recognition on text in the identification document; or
scanning an image of a face on the identification document.

15. The method of claim 13, wherein the obtaining of the information representing whether the identification data matches the biometric data comprises:
retrieving, from a biometric database, stored biometric data corresponding to the identification data; and
comparing the biometric data captured by the biometric sensor to the stored biometric data corresponding to the identification data.

16. The method of claim 13, further comprising retrieving, using an authorization document of the user, authorization data of the product from an authorization database, wherein the authorization document references the product.

17. The method of claim 16, further comprising:
determining, using the identity authentication module, whether the authorization data corresponding to the product is valid; and
dispensing, using the product dispenser, the product stored in the storage container to the user responsive to the authorization data being valid.

18. A mobile device configured to:
read security data and identification data of a user from an identification document of the user;
obtain information representing whether the security data matches the identification data;
capture first biometric data of the user;
obtain information representing whether the identification data matches the first biometric data; and
responsive to the identification data matching the first biometric data, transmit, to an automated dispensing machine, information representing that the identification data matches the first biometric data, wherein the automated dispensing machine is communicatively coupled to the mobile device and configured to:
capture second biometric data of the user; and
responsive to the second biometric data matching the first biometric data, dispense, to the user, a product stored in the automated dispensing machine.

19. The mobile device of claim 18, wherein the mobile device is configured to obtain the information representing whether the identification data matches the first biometric data by performing steps to:
retrieve, from a biometric database, stored biometric data corresponding to the identification data; and
compare the first biometric data to the stored biometric data corresponding to the identification data.

20. The mobile device of claim 18, further configured to:
retrieve, using an authorization document of the user, authorization data corresponding to the product from an authorization database, wherein the authorization document references the product; and
determine whether the authorization data corresponding to the product is valid.
